(19) United States
(12) Patent Application Publication
(10) Pub. No.: US 2024/0210877 A1
(43) Pub. Date: Jun. 27, 2024

(54) OPTICAL SYSTEM FOR FLOATING HOLOGRAMS, COMPRISING A PLURALITY OF SWITCHABLE OPTICAL CHANNELS

(71) Applicant: Carl Zeiss Jena GmbH, Jena (DE)

(72) Inventors: Viktor SCHÜTZ, Jena (DE); Petr VOJTISEK, Jena (DE); Siemen KÜHL, Jena (DE); Marc JUNGHANS, Jena (DE)

(73) Assignee: Carl Zeiss Jena GmbH, Jena (DE)

(21) Appl. No.: 18/557,400

(22) PCT Filed: Apr. 27, 2022
(86) PCT No.: PCT/EP2022/061185

§ 371 Date: Oct. 26, 2023

(30) Foreign Application Priority Data
Apr. 27, 2021 (DE) 102021110734.2
Aug. 19, 2021 (DE) 102021121550.1
Sep. 10, 2021 (DE) 102021123515.4

(51) Int. Cl. G03H 1/02; G03H 1/04; G03H 1/22

(52) U.S. Cl. CPC G03H 1/0248; G03H 1/2286; G03H 2001/0439

(57) ABSTRACT

An optical system comprises a plurality of optical channels. A control unit can switch light sources of the optical channels separately on and off. In this way, different image motifs of a hologram can be illuminated by a number of different illumination sources of at least one imaging holographic optical element.

### RELATED APPLICATIONS

This application is a U.S. National Stage Application of International Application No. PCT/EP2022/061185, filed Apr. 27, 2022, which claims priority from German Patent Application Nos. DE102021110734.2, filed on Apr. 27, 2021, DE102021121550.1, filed on Aug. 19, 2021, and DE102021123515.4 filed on Sep. 10, 2021, all of which are hereby fully incorporated herein by reference.

### FIELD OF THE INVENTION

Various examples of the disclosure relate to a system comprising a plurality of optical channels for generating a floating hologram. The various optical channels are individually controllable by a controller.

### BACKGROUND OF THE INVENTION

Techniques for generating a floating hologram by means of an imaging holographic optical element (HOE) are known. Such a floating hologram is generated in a volume arranged outside of the imaging HOE. This means that the hologram is reconstructed offset from the imaging HOE. This can generate an optical “floating effect”; the hologram stands freely in space.

It was determined that the floating hologram of corresponding optical systems may have a comparatively static and not very interactive form. Moreover, such optical systems are often comparatively large.

### SUMMARY OF THE INVENTION

Accordingly, aspects of the invention provide an optical system which is able to generate a floating hologram. In particular, aspects of the invention to provide an optical system which is able to dynamically provide the one or more holograms, as well as provide a compact optical system.

An optical system comprises a plurality of optical channels which are able to be switched on and off on an individual basis. This means that light can in each case be selectively transmitted along one or more beam paths of the various optical channels. Thus, the light sources can be controlled on an individual basis. The light is incident on one or more imaging HOEs, which respectively generate corresponding parts of the floating hologram. As a result, one or more image motifs of the hologram can be switched on and off, depending on which optical channel is controlled.

An optical system comprises at least one imaging HOE. The at least one HOE is configured to generate a floating hologram on the basis of light. The floating hologram is reconstructed in a volume outside of the at least one imaging HOE. Consequently, the floating hologram is arranged in a volume outside of the at least one imaging HOE. The optical system moreover comprises a plurality of optical channels. The plurality of optical channels each comprise a light source and a beam path. The plurality of optical channels are configured to guide/conduct the light along the respective beam path toward the at least one imaging HOE. The controller is configured to individually control the light source for the plurality of optical channels.

Thus, individually controlling the light sources may mean that individual light sources can be switched on and off separately from other light sources. This means that light can be selectively transmitted or not transmitted along the various beam paths of the various optical channels. In other words, this means that the various optical channels can be controlled on an individual basis, which is to say be switched on an individual basis.

The various optical channels may be associated with different image motifs of the hologram. These different image motifs may provide different parts of the floating hologram. Different image motifs may reproduce different geometries or images. Different image motifs may also reproduce the same geometries or images, albeit in different colors.

A computer-implemented method comprises the individual control of a plurality of light sources of an optical system. In the process, the plurality of light sources are controlled on the basis of one or more decision criteria. Depending on the result of a corresponding check of the one or more decision criteria, it is thus possible to switch on or switch off a certain light source of the plurality of light sources, and another light source of the plurality of light sources can be switched off or switched on. This check can be implemented on an individual basis for each light source.

In this case, the plurality of light sources are assigned to the plurality of optical channels of the optical system. The optical channels each comprise an associated beam path. The optical channels are each configured to guide the light transmitted by the respective light source of the plurality of light sources toward at least one imaging HOE of the optical system. In this case, the at least one imaging HOE is configured to generate a floating hologram in a volume outside of the at least one imaging HOE on the basis of the light.

The features set out above and features that are described hereinbelow can be used not only in the corresponding combinations explicitly set out, but also in further combinations or in isolation, without departing from the scope of protection of the present invention.

### BRIEF DESCRIPTION OF THE DRAWINGS

FIG. 1 is a schematic view of an optical system according to various examples, which comprises an optical channel, a controller, and a depth sensor.

FIG. 2 illustrates an exemplary structural realization of the optical system from FIG. 1 according to various examples.

FIG. 3 illustrates spectral filtering, which may be provided by a light-shaping HOE which realizes a deflection element according to various examples.

FIG. 4 illustrates an exemplary realization of the optical system from FIG. 1 according to various examples.

FIG. 5 illustrates an exemplary realization of the optical system from FIG. 1 according to various examples.

FIG. 6A illustrates an exemplary integration of the optical system with a mirror according to various examples.

FIG. 6B is a perspective view of an exemplary realization of the optical system according to FIG. 2.

FIG. 7 is a flowchart of an exemplary method.

FIG. 8 is a schematic view of an optical system according to various examples, which comprises an imaging HOE and an optical waveguide.

FIG. 9 is a perspective view of an exemplary realization of the optical system from FIG. 8 according to various examples.

FIG. 10 is a of the realization from FIG. 9.

FIG. 11 is a schematic view of an optical system according to various examples, which comprises a plurality of optical channels.

FIG. 12 is a schematic view of an optical system according to various examples, which comprises a plurality of optical channels.

FIG. 13 is a schematic view of an optical system according to various examples, which comprises a plurality of optical channels.

FIG. 14 is a perspective view of an exemplary realization of the optical system from one of FIGS. 11 to 13 according to various examples.

FIG. 15 is a perspective view of an exemplary realization of the optical system from one of FIGS. 11 to 13 according to various examples.

FIG. 16 is a side view of an exemplary realization of the optical system from one of FIGS. 11 to 13 according to various examples.

FIG. 17 is a perspective view of the realization of the optical system from FIG. 16.

FIG. 18 is a perspective view of an exemplary realization of the optical system from one of FIGS. 11 to 13 according to various examples.

FIG. 19 is a perspective view of the realization of the optical system from FIG. 18.

FIG. 20 schematically illustrates a controller for a plurality of optical channels according to various examples.

FIG. 21 is a flowchart of an exemplary method.

FIG. 22 schematically illustrates a menu level of a GUI according to various examples.

### DETAILED DESCRIPTION OF THE INVENTION

The properties, features and advantages of this invention described above and the way in which they are achieved will become clearer and more clearly understood in association with the following description of the exemplary embodiments which are explained in greater detail in association with the drawings.

The present invention is explained in greater detail below on the basis of preferred embodiments with reference to the drawings. In the figures, identical reference signs denote identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art.

Techniques which make it possible to generate a floating hologram are described hereinbelow. The hologram can reproduce an image motif, for instance a button or an information sign. The hologram could also reproduce a plurality of image motifs. By way of example, an image could be assembled from a plurality of image motifs, or separate image motifs could be reproduced.

To this end, an optical system comprising a plurality of optical channels is used. Each optical channel may respectively have an assigned light source and a beam path. The optical channels are configured to respectively transmit the light along the respective beam path toward at least one imaging HOE. The at least one imaging HOE is configured to generate a floating hologram on the basis of the light. This floating hologram is reconstructed or arranged in a volume outside of the at least one imaging HOE.

The hologram generated by means of a corresponding optical system may have a particularly high floating height and/or a particularly large depth effect. By way of example, a distance between a volume, in which the hologram is depicted in the case of a suitable illumination of the at least one imaging HOE, and the at least one imaging HOE could be no less than 60% of the lateral dimensions (perpendicular to the distance) of a refractive index-modulated region of the at least one imaging HOE.

The hologram may have one or more image motifs as a matter of principle. The various image motifs can be generated by light which has run through different beam paths or is assigned to different optical channels.

The at least one imaging HOE can be realized as a volume HOE, which is to say it may have a variation of the refractive index in 3-D. A corresponding refractive index-modulated region has a 3-D extent. This variation of the refractive index refracts the light with a diffraction pattern, whereby the hologram is formed. The volume HOE is distinct from a surface HOE, in which a modulation of the surface of a substrate brings about the diffraction pattern. By way of example, the surface could be wavy.

The at least one imaging HOE can be realized as a transmission HOE or as a reflection HOE. In the case of a transmission HOE, the refractive index-modulated region is illuminated from one side and the hologram is generated in a volume facing the opposite side. In the case of reflection HOEs, the refractive index-modulated region is illuminated from one side and the hologram is generated in a volume facing the same side.

For example, it would be possible that a beam path of the light is incident on the imaging HOE in edge lit geometry. This means that the at least one imaging HOE comprises a substrate (made of a transparent material which is optically denser than air), to which the refractive index-modulated region has been applied. A corresponding beam path is coupled into the substrate on the narrow side and then passes through the substrate—e.g., glass or polymethylmethacrylate—before it is incident on the refractive index-modulated region. Typically, the substrate has a layer thickness that is substantially greater than the layer thickness of the refractive index-modulated region. The so-called reconstruction angle denotes the angle at which the light is incident on the refractive index-modulated region. The latter may be arranged along a surface of the at least one imaging HOE. Light not diffracted by the refractive index-modulated region for the purpose of generating the hologram can then experience total-internal reflection at the surface of the at least one imaging HOE and be reflected back into the substrate.

It would be conceivable in some variants for an absorbent material to absorb such light that has been reflected back (beam dump); as a result, the reproduction of the hologram is not disturbed by “background light”. However, in other examples, it would also be conceivable for the substrate to realize an optical waveguide. Then, the light reflected back at the surface of the at least one imaging HOE is reflected at a further surface of the optical waveguide, and it is incident again on the at least one imaging HOE. Thus, the optical waveguide may be arranged below the at least one imaging HOE and extend along the at least one imaging HOE, and the light propagating in the optical waveguide can be used to fully illuminate the at least one imaging HOE. In this case, the at least one imaging HOE is applied to an outer surface of the optical waveguide. The use of an optical waveguide enables a particularly compact design because the thickness of the substrate forming the optical waveguide can be less than the lateral dimensions of the at least one imaging HOE. By way of example, it would be conceivable that a thickness of the optical waveguide perpendicular to the at least one imaging HOE (i.e., along a direction extending away from the imaging HOE) is no more than 20% of a length of the at least one imaging HOE along the optical waveguide.

By way of example, a plurality of imaging HOEs could be attached to a common optical waveguide, through which the light of a plurality of optical channels runs. It would also be possible to use one optical waveguide per optical channel.

The light sources used preferably emit light in the visible spectrum, in particular between 380 nm and 780 nm. One or more light-emitting diodes can be used as a light source in the various examples described herein. Light-emitting diodes are particularly simple, durable, and inexpensive and have sufficient optical properties, especially in relation to the coherence of the emitted light, with regard to a multiplicity of lighting functions, in particular holographic lighting functions. Light-emitting diodes are particularly efficient. For example, a light-emitting diode could comprise a light emitter (active area emitting photons) with dimensions between 0.5×0.5 mm² and 1×1 mm². In particular, the use of small emitter surfaces for the aforementioned applications can be advantageous.

The optical system may comprise one light source per optical channel. This light source is configured to transmit the light along the respective beam path to the at least one imaging HOE. For example, the beam path can be defined by the optical axis of the corresponding optical channel with the optical components. The light propagates along the beam path to the at least one imaging HOE.

By way of example, it would be conceivable for each optical channel to be assigned a corresponding imaging HOE.

However, it would also be conceivable for a single imaging HOE to be assigned to a plurality of optical channels. Thus, this would mean that a continuous refractive index-modulated region of the imaging HOE is present (which was exposed phase coherently) and illuminated by light from a plurality of beam paths. Different techniques can be used to nevertheless generate different image motifs of the hologram through the various optical channels. These techniques are summarized below in the context of Table 1.

TABLE 1
Different variants for the joint use (“multiplexing”) of a
common imaging HOE with light assigned to different optical channels.
Thus, the light can be incident on the imaging HOE from different
directions. As a result, different image motifs can be generated
by the various optical channels. The hologram can be flexibly put
together by the various image motifs as a result of the optical
channels being able to be switched on an individual basis.

| | |
|---|---|
| Different | For example, the light from different beam paths can be |
| recon- | incident on the common imaging HOE from different angles. |
| struction | This can enable different construction angles. As a result, it |
| angles | may be possible to enable different image motifs by |
| | separating the reconstruction in angular space. |
| Different | For example, light at different wavelengths can be used in |
| wave- | order to thus generate different image motifs - separated in |
| lengths | the spectral range. The image motifs may then appear in |
| | different colors. |
| Different | The refractive index-modulated region of the common |
| partial | imaging HOE may be designed with a large lateral area. Then, |
| regions | different partial regions of the refractive index-modulated |
| | region can be illuminated by the light from the various beam |
| | paths. This allows different image motifs to be |
| | reconstructed. Thus, there is a separation in real space. |

Various examples are based on the insight that a particularly compact structure of a corresponding optical system can be achieved by virtue of using at least one optical deflection element. This means that the light is transmitted by the light source along a respective beam path and then deflected by the optical deflection element toward at least one imaging HOE. This allows the light source to be arranged adjacent to or behind the at least one imaging HOE. In other words: at least one of the at least one imaging HOEs can be arranged between the volume (in which the hologram is reconstructed) and the respective light source. What is achieved as a result of the optical deflection element is that the light source does not transmit the light directly to the at least one imaging HOE, but instead initially transmits it to the deflection element. This can achieve illuminations of the refractive index-modulated region of the at least one imaging HOE over a larger area than in the case of a direct illumination. It is possible to obtain flatter reconstruction angles. This improves the representation of the image motifs of the hologram.

By way of example, such a deflection element could be implemented as a mirror. The deflection element could also be implemented as an optical prism or by an optical waveguide which guides the light in an optically dense medium by way of total-internal reflection.

More complicated realizations of the deflection element would also be conceivable. In particular, realizations of the deflection element which—in addition to the deflection of the light—also provide other light-shaping functionalities would be conceivable. To this end, use can also be made of an HOE, which is referred to hereinbelow as light-shaping HOE.

Various examples are based on the insight that a further improvement of the illumination of the imaging HOE can be achieved by using a light-shaping HOE which is arranged in the beam path between the light source and the imaging HOE and which—in addition to the light-shaping functionality—also deflects the light. The light-shaping HOE can thus realize the inverse element.

Some such light-shaping functionalities which can be provided by the light-shaping HOE are described hereinbelow in the context of Table 2.

TABLE 2
Various light-shaping functionalities that may be provided
by the light-shaping HOE. A homogeneous angular and
wavelength spectrum of the illumination of the imaging
HOE can be obtained by means of such light-shaping functionalities,
with the result that it is possible to reconstruct a
hologram which has a great distance from the refractive
index-modulated region of the at least one imaging HOE
and which has a large depth of field.

| | Brief | |
|---|---|---|
| | description | Exemplary details |
| I | Spectral | The light-shaping HOE can be configured to perform |
| | filtering | spectral filtering of the light. This means that light at |
| | | specific wavelengths is transmitted by the light- |
| | | shaping HOE in the direction of the imaging HOE - by |
| | | way of suitable diffraction - while light at other |
| | | wavelengths is not transmitted in the direction of the |
| | | imaging HOE. |
| | | By way of such spectral filtering, it is possible to |
| | | obtain particularly monochromatic illumination or an |
| | | illumination with a comparatively narrow wavelength |
| | | spectrum. This allows the hologram to be generated |
| | | with particularly high quality. |
| II | Filtering | The light-shaping HOE can further be configured to |
| | the angular | filter the angular spectrum of the light. The angular |
| | spectrum | spectrum is characterized by the shape of the |
| | | wavefront of the propagating light along the beam |
| | | path. For example, a plane wave would cause the at |
| | | least one imaging HOE to be illuminated from one |
| | | angle only, or would cause light to propagate along |
| | | the beam path without divergence. |
| | | In an example, a reduced divergence of the light along |
| | | the beam path can be generated by filtering the |
| | | angular spectrum. Thus, the light can be collimated. |
| | | Virtually plane wavefronts of the light can be |
| | | generated by reducing the divergence. |
| | | Post filtering, the angular spectrum could be for |
| | | example less than 2°, optionally less than 1° and |
| | | further optionally less than 0.5°. |
| | | Phrased more generally, the filtering allows the |
| | | angular spectrum to be brought into line with the |
| | | angular spectrum of reference light used during the |
| | | exposure of the imaging HOE. |
| | | A particularly high-quality hologram can be generated |
| | | by such filtering in the angular space. |

In principle, various realizations for the light-shaping HOE are conceivable. By way of example, it would be possible for the light-shaping HOE to deflect the beam path in reflection geometry. That is to say, a reflection HOE can be used. A reflection HOE is wavelength-selective, which is to say only light from a tight wavelength spectrum is efficiently diffracted for a specific exit angle. As a result, spectral filtering according to Table 2: example I can be achieved. For example, a full width at half maximum of the wavelength spectrum of the light that is no greater than 10 nm, in particular no greater than 5 nm, could be obtained post spectral filtering. A better reconstruction of the image in the form of the hologram can be achieved as a result, because smearing and ghost images—which could otherwise arise in the case of a broadband illumination of the at least one imaging HOE—are avoided.

Similar to what was described above in the context of the at least one imaging HOE, it would be conceivable for the light-shaping HOE to be attached to an outer surface of an optical waveguide. The light-shaping HOE and the imaging HOE can be applied to different outer surfaces of the optical waveguide.

By way of example, each optical channel may have an assigned deflection element or, in particular, an assigned light-shaping HOE. The light-shaping HOEs of different optical channels may be formed by a common grating structure, which is to say different regions of the common grating structure are illuminated by the light from different optical channels. However, separate grating structures could also be used.

As a general rule, there are different arrangement options for the optical channels. The channels can be arranged next to one another, with the result that a line-by-line or column-by-column reconstruction is made possible. This means that the beam paths of the various optical channels run parallel or perpendicular to one another, at least in portions. The optical channels can likewise be arranged in a grating structure, with the result that a line-by-line and column-by-column reconstruction is provided. Furthermore, the channels may also be arranged relative to one another in a diagonal direction or at further azimuthal angles. Thus, an angle between the beam paths can for example range from 450 to 90°.

The beam paths can be separated by stop elements. This means that the beam paths can be defined, for example, by the optical axes of specific optical elements of the respective optical channel, for instance by corresponding collimator lenses.

It is possible that the optical system comprises a controller. This controller can switch the various optical channels. This means that the controller may be configured to individually control the light sources for the plurality of optical channels.

For example, the controller could comprise a processor, for example a microprocessor, an application-specific integrated circuit or a field-programmable switchable array. On the basis of program code, the controller is able to execute one or more techniques for switching the optical channels.

By way of example, it would be conceivable for the controller to be configured to control the light sources for the plurality of optical channels on the basis of a measurement signal of a depth sensor (sometimes also referred to as distance sensor) in the optical system. The depth sensor may be configured to detect an object in the volume or adjacent to the volume, and output a corresponding measurement signal.

For example, as seen from the user's perspective, the depth sensor may be arranged behind the imaging HOE. This means the imaging HOE may be arranged between the volume (in which the hologram is reconstructed) and the depth sensor.

In particular, the depth sensor can thus be configured to determine a lateral position (X-Y-position) and a distance (Z-position) of the object. The light sources for the various optical channels can then be controlled on the basis of such properties.

Different realizations of the depth sensor can be used as a matter of principle. For example, it would be possible to use a time-of-flight-based sensor (TOF sensor), which determines the depth position of the object on the basis of time-of-flight measurements of light pulses. Use could also be made of laser light, which is to say a lidar (light detection and ranging) sensor could be used. In principle, it would also be conceivable to use a radar sensor which determines a depth position of the object on the basis of radar waves. It is likewise conceivable to use an ultrasonic sensor in order to determine a depth position of the object on the basis of ultrasonic waves. When an optical depth sensor is used, provision can be made in particular for the wavelength of the light used to determine the depth position to differ from the wavelength of the light used to generate the floating hologram. For example, light from the infrared range can be used for the depth sensor and light from the visible range can be used for the floating hologram. By using different wavelengths, it is possible in particular to avoid the depth sensor being influenced by the hologram. It is consequently possible to detect an object with a greater reliability in the volume or adjacent to the volume in which the hologram is reconstructed. In particular, it is possible to determine a lateral position and a distance of the object more accurately.

It would be possible for the controller to be configured to use the measurement signal as a basis for determining state data indicative of the user actuation of an interaction element displayed as an image motif by the hologram.

This therefore means that image motifs which are reconstructed by the light from different optical channels can represent interaction elements—for example buttons, sliders, etc.—of a graphical user interface (GUI). Different interaction elements can be displayed by different optical channels. It would then be possible to use the measurement signal from the depth sensor to determine whether a user is actuating one of these interaction elements.

In the process, different factors can be taken into account within the scope of such a determination of the user actuation. For example, a check could be carried out as to whether a fingertip of the user is arranged in the corresponding partial region of the volume in which the interaction element is arranged (i.e., whether the user “presses” a button, for example). For example, it would be conceivable to determine such state data on the basis of an orientation of the finger with respect to the volume. That is to say, a check could be carried out as to whether the finger points at a corresponding interaction element or is oriented facing away therefrom. In particular, it would for example be conceivable for a parallax of the observer of the hologram to be determined during a corresponding actuation. In particular, a parallax of the observer can be understood to mean a viewing direction of the observer in relation to the hologram. That is to say, a check could be carried out as to whether a user observes the hologram from a particularly oblique angle—and hence the finger is also directed obliquely at the volume—with the result that the traction elements are arranged offset in relation to a spatial position in which they are perceived by an observer at a comparatively perpendicular angle. For example, this can be determined by virtue of determining whether the orientation of the finger is oriented obliquely or perpendicularly with respect to the volume. Phrased in general, the parallax of the observer can be determined on the basis of the orientation of the finger. As an alternative or in addition, it would also be possible to determine a viewing angle of the observer by identifying eyes in an image captured by a surround camera.

In particular, the depth sensor can be configured to determine the position and orientation of a finger. By way of example, the depth sensor can be configured to detect a finger situated in a volume of approx. 15 cm by 15 cm by 3 cm. In examples, a spatial resolution of the depth sensor can be 10 by 10 pixels. Such a low resolution may be sufficient to determine the orientation of a finger. Further, a depth sensor which allows the detection of the finger or the determination of its orientation at regular temporal intervals, for example every 100 ms, may be provided. By way of example, movements of the finger can be identified in this way.

The controller could be configured to identify a gesture of a finger or a hand of the user on the basis of the measurement signal from the depth sensor. For example, exemplary gestures would be “double-click”; “swipe”; etc. In this case, the gesture could be determined in relation to the volume. This means that a “double-click” must have a specific position vis-à-vis the volume, for example in particular vis-h-vis a partial region in which an interaction element is displayed, in order to be identified as a gesture.

Algorithms known in principle to a person skilled in the art can be used to identify objects, the orientation of objects such as fingers, and/or gestures. Machine-learned algorithms could be used. The specific realization of such algorithms is not decisive for the functionality of the techniques described herein, and hence no further details are specified.

As a general rule, the optical systems described herein may be integrated in different applications. For example, it would be conceivable for the system to comprise the optical system and a mirror having a mirror surface which extends along the at least one imaging HOE and which is arranged between the at least one imaging HOE and the volume in which the floating hologram is generated. Byway of example, it could be possible to generate a graphical user interface having a plurality of interaction elements, which “float” in front of the mirror surface. For example, a radio could be controlled in this way, or an image reproduction of an electronic visual display integrated in the mirror at a different location.

For example, a further application would be the integration in an electronic visual display. Thus, a system may comprise the optical system and an electronic visual display which extends along the at least one imaging HOE. Thus, the at least one imaging HOE may be arranged between the electronic visual display and the volume. In this way, it would be possible for example to realize a graphical user interface with a plurality of interaction elements which floats over the electronic visual display of a television or a computer monitor.

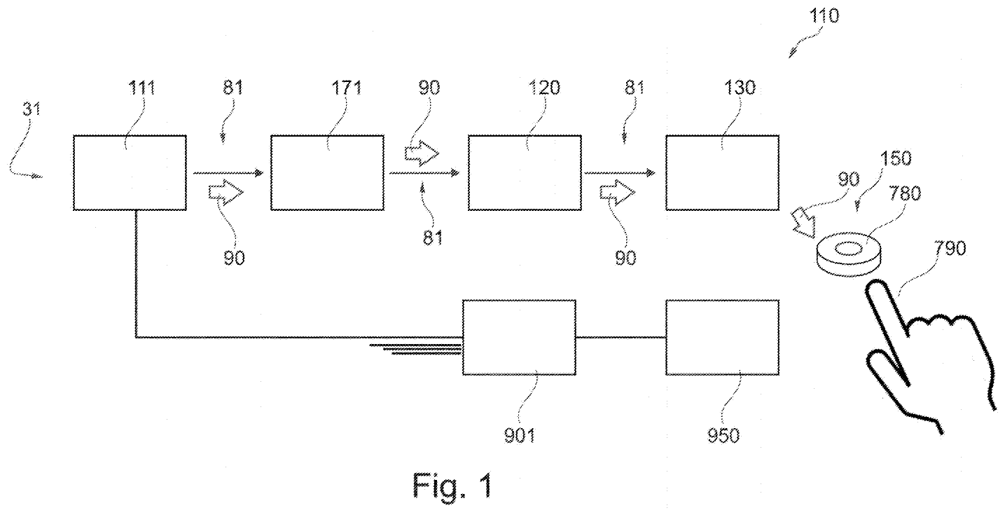

FIG. 1 illustrates aspects in connection with an optical system 110. FIG. 1 is a schematic illustration of the optical system 110, which is configured to generate a hologram 150. The hologram 150 comprises a single image motif 780, in this case a button as an interaction element of a GUI.

In FIG. 1, a single optical channel 31 is shown by way of example for the purpose of explaining the functionality. However, the optical system could have further optical channels which are configured like the optical channel 31.

The optical system 110 comprises a light source 111. The light source 111 can be realized by one or more light-emitting diodes. The light source 111 is configured to transmit light 90 along a beam path 81. The light 90 is used to generate the hologram 150. This defines a corresponding optical channel 31.

Various optical components 171, 120, 130 are arranged along the beam path 81.

By way of example, it would be possible for a refractive or mirror-optical optical element 171, 172 to be arranged adjacent to the light source 111 in the beam path 81 between the light source 81. This refractive or mirror-optical optical element is configured to collect the light 90. A greater light yield may be obtained as a result.

For example, the optical element 171, 172 could be realized by a concave mirror or a lens—i.e., a collimator lens.

The light 90 propagates onward along the beam path 81, in the direction of a deflection element 120. By way of example, the deflection element 120 can be realized as a light-shaping HOE 120. Various light-shaping functionalities which can be provided by the light-shaping HOE 120 were described hereinabove in the context of Table 2.

The light 90—after being deflected by the deflection element 120 (not shown in the schematic view of FIG. 1)—then propagates onward along the beam path 81, to an imaging HOE 130. The imaging HOE 130 is configured to generate the floating hologram 150 on the basis of light 90.

The optical system also comprises a controller 901. The controller 901 is configured to control the light source 111. This means that the controller 901 can switch the light source 111 on or off.

In this case, the controller 901 can be configured to control the light sources of a plurality of optical channels (only one optical channel 31 is shown in FIG. 1) on an individual basis. In this way, light can selectively be transmitted along the various beam paths of the plurality of optical channels, and different image motifs 780 of the hologram 150 can be switched on or off.

As a general rule, different decision criteria with regard to switching the different light sources on or off are conceivable here. By way of example, it would be conceivable that the controller 101 is configured to control the light sources for a plurality of optical channels on the basis of a measurement signal from a depth sensor 950. The depth sensor 950 is configured to detect an object 790, in this case the fingers of a user, in the volume in which the hologram 150 is displayed or else adjacent to the volume, and to output the measurement signal to the controller 901.

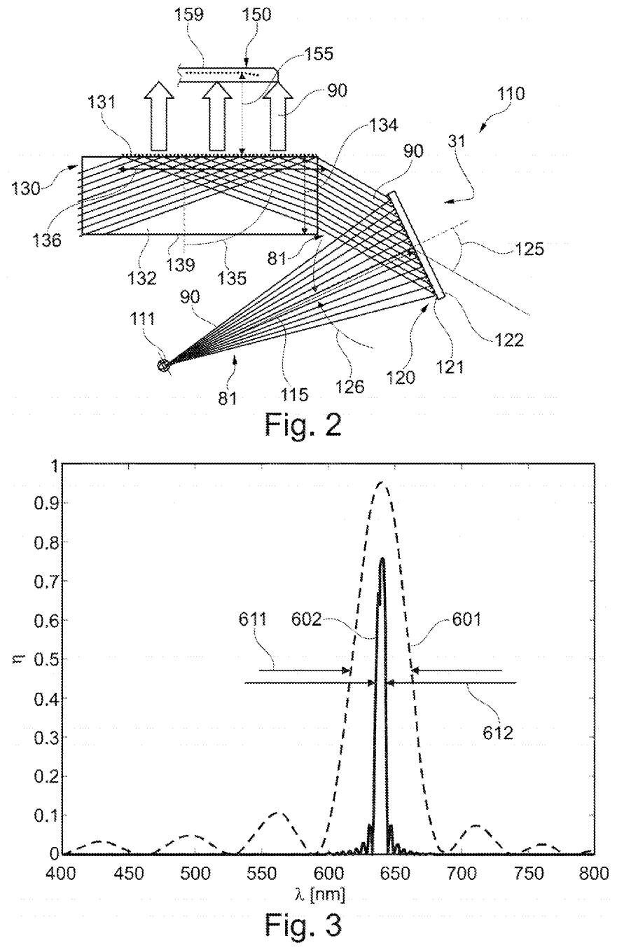

Various structural realizations of the beam path 31 are conceivable. Some realizations are described hereinafter, for example in the context of FIG. 2.

FIG. 2 illustrates aspects in connection with the optical system 110. In particular, FIG. 2 illustrates an exemplary structural realization of the optical channel 31. In the example of FIG. 2, the optical system 110 comprises no refractive or mirror-optical optical element which would be arranged in the beam path 81 between the light source 111 and the light-shaping HOE 120.

The light source 111 transmits light 90 with a significant divergence, which is to say with a comparatively broad angular spectrum. FIG. 2 shows, by way of example, rays of light 90 along the beam path 81 (“ray tracing”) which defines the optical channel 31.

The light 90 is incident on the light-shaping HOE 120. The light-shaping HOE 120 comprises a substrate 122 and a refractive index-modulated region 121. The light-shaping HOE 120 deflects light 90 along the beam path in reflection geometry. Moreover, spectral filtering is implemented. The light 90 incident on the imaging HOE 130 is more narrowband than the light 90 transmitted by the light source 111 as a result of the spectral filtering (FIG. 3 illustrates the spectrum 601 of the unfiltered light and the spectrum 602 of the filtered light, with respective associated full widths at half maximum 611, 612).

FIG. 2 also depicts the reflection angle 125, at which the light-shaping HOE 120 reflects the light along the beam path 81. Moreover, the angle of incidence 126 of light 90 on the light-shaping HOE 120 is also depicted. In this case, these angles 125, 126 correspond to the angles at which reference light is incident on the imaging HOE 120 during the exposure of the light-shaping HOE 120 from two different laser sources.

FIG. 2 also depicts what is known as a reconstruction angle 135. The reconstruction angle 135 denotes the direction along which the light 90 along the beam path 81 is incident on the refractive index-modulated region 131 of the imaging HOE 130. This reconstruction angle 135 is defined by the reflection angle 125, the relative arrangement of the light-shaping HOE 120 with respect to the imaging HOE 130, and the refraction of the interface of air to the substrate 132.

Then, the hologram 150 is generated on the basis of the light 90 in a volume 159 which is arranged at a distance 155 from the refractive index-modulated region 131 of the imaging HOE 130. Thus, a floating hologram 150 is generated.

The thickness 134 of the substrate 132 is dimensioned to be comparatively large in the example of FIG. 2. In particular, the thickness 134 of the substrate 132 is dimensioned such that the light 90 illuminates the entire lateral surface of the refractive index-modulated region 131 of the imaging HOE 130 without being reflected at a back side 139 of the substrate 132 distant from the imaging HOE 130. This means that no optical waveguide functionality is realized by the substrate 132 in the illustrated example of FIG. 2. For example, a light-absorbing material (a so-called “beam dump”) could be attached to the back side 139.

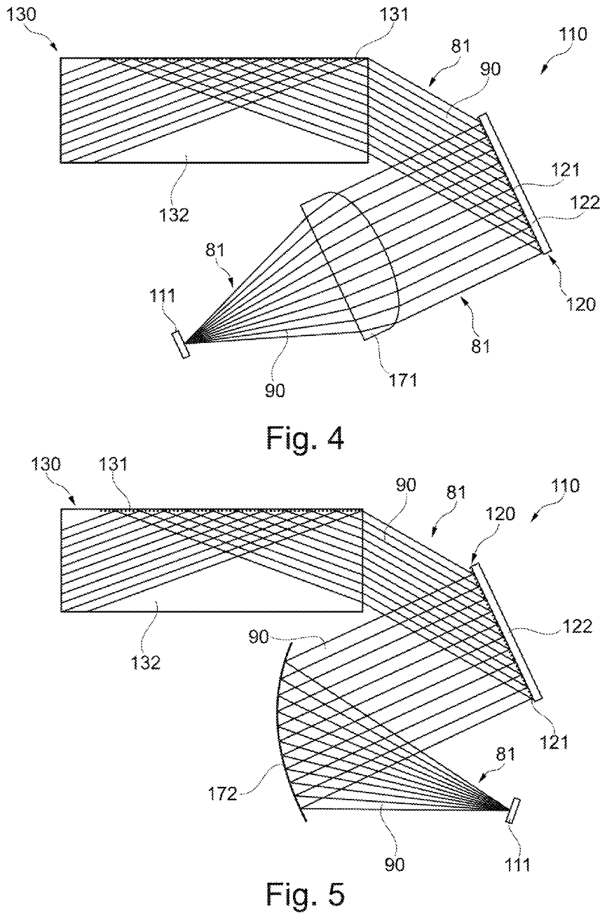

One or more further beam-shaping components can be arranged along the beam path 81 between the light source 111 and the light-shaping HOE 120 in various examples. By way of example, use could be made of a lens 171—cf. FIG. 4—or a mirror 172—cf. FIG. 5. The light yield can be increased as a result, which is to say a greater amount of light 90 transmitted by the light source 111 can be used to illuminate the imaging HOE 130.

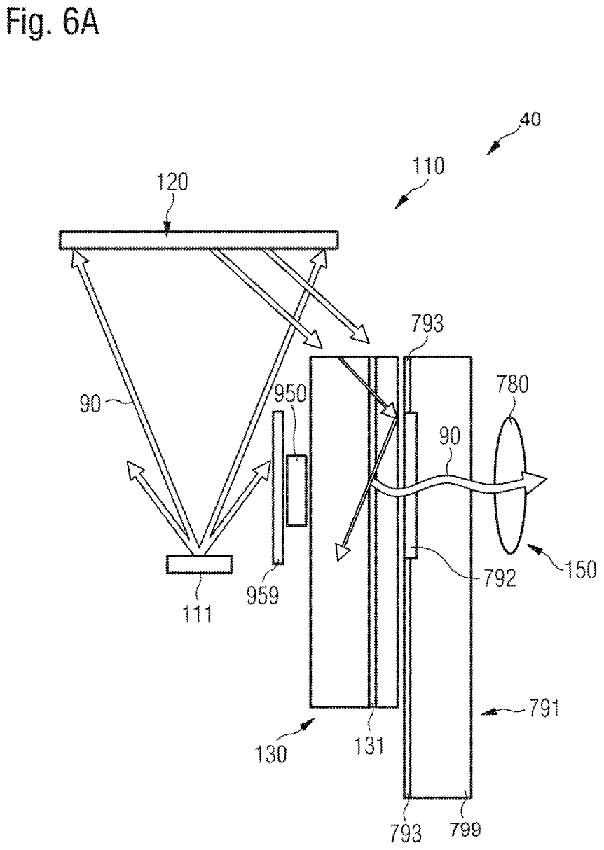

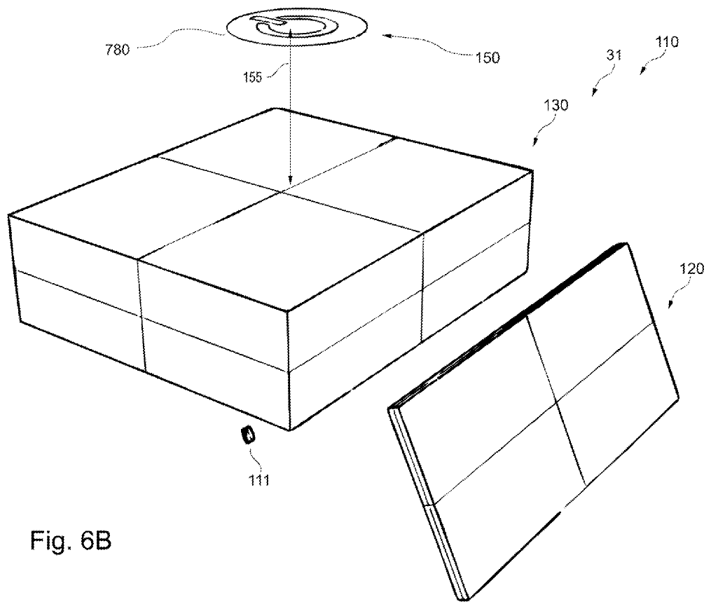

FIG. 6A illustrates an exemplary implementation of the optical system 110 in conjunction with a mirror 791, whereby a corresponding system 40 is defined. The mirror 791 comprises a mirror surface 793, for example realized as a thin metallic back-side coating of a substrate 799. A cutout 792 is also provided in the mirror surface 793 and arranged adjacent to the imaging HOE 130. The light 90 can pass through the cutout 792. For example, a partly reflective layer could be situated in the cutout 792, said layer allowing the light 90 in the wavelength range of the light source 111 to pass and reflecting ambient light. A bandpass filter could be used.

It is evident from FIG. 6A that the imaging HOE 130 extends along the mirror surface 793. In this case, the mirror surface 793 is arranged between the volume in which the hologram 150 is formed and the imaging HOE 130. The imaging HOE 130, in turn, is arranged between the mirror surface 793 and the light source 111, with a stop 959 being provided.

A depth sensor 950 is also provided in the example of FIG. 6A. In this case, the imaging HOE 130 is arranged between the volume in which the hologram 150 is reconstructed and the depth sensor 950.

For example, if the depth sensor 950 uses light (rather than microwaves), then it would be possible to use light from a spectral range which is not influenced by the refractive index-modulated region 131 of the imaging HOE 130. For example, the light 90 used to reconstruct the hologram 150 could be located in the visible spectrum, while the light from the depth sensor 950 could be located in the infrared range.

The combination of the optical system 110 with a mirror 791 is but one example. It would also be conceivable for a system having an electronic visual display to be formed, the latter extending along the imaging HOE 130. In this case, the imaging HOE 130 could then be arranged between the electronic visual display and the volume, which is to say the electronic visual display could be arranged behind the imaging HOE 130 (from the observer's perspective).

FIG. 6B is a perspective view of the beam path 31. FIG. 6B depicts the floating height 155 of an image motif 780 (an on/off button) above the HOE 130. Moreover, the deflection element 120, for example a light-shaping HOE, is visible.

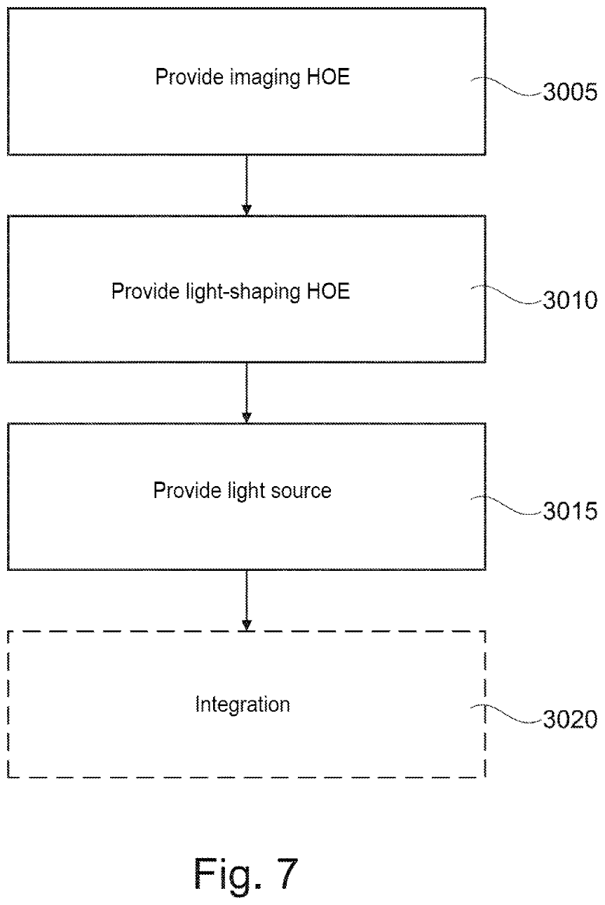

FIG. 7 shows a flowchart of an exemplary method for producing an optical system. By way of example, the optical system 110 according to any of the examples discussed hereinabove can be produced using the method of FIG. 7. Optional blocks are depicted using dashed lines in FIG. 7.

An imaging HOE is initially provided in block 3005. For example, the imaging HOE 130 can be realized in accordance with the above-described examples.

For example, block 3005 could comprise an exposure of the imaging HOE 130 with reference light from a plurality of interfering laser light sources. The refractive index-modulated region can be formed on a corresponding substrate in this way. The reconstruction angle 135 is defined thereby.

In principle, a person skilled in the art is aware of the techniques for exposing an imaging HOE, with the result that no further details need to be specified here.

The provision of a light-shaping HOE is implemented in block 3010. For example, the light-shaping HOE 120 can be provided in accordance with the above-described examples.

Block 3010 can comprise the exposure of the light-shaping HOE 120 with reference light from a plurality of interfering laser light sources.

A light source can be provided in block 3015. In particular, this light source can be arranged at a suitable distance from the light-shaping HOE.

Then, the integration of the optical system thus obtained into a further unit, for example a mirror, an electronic visual display, or an interior trim panel of a motor vehicle, could be optionally implemented in block 3020.

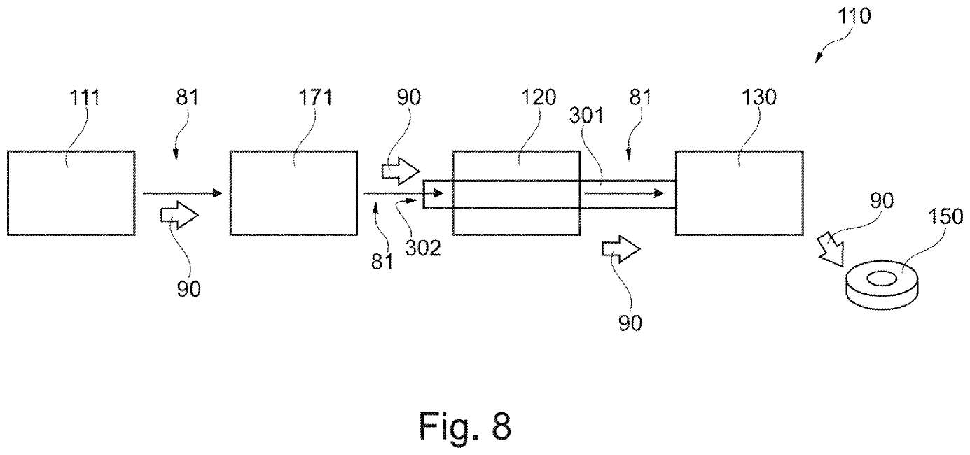

FIG. 8 illustrates aspects in connection with the optical system 110. FIG. 8 is a schematic illustration of the optical system 110, which is configured to generate a hologram 150. In principle, the optical system 110 from FIG. 8 corresponds to the optical system 110 from FIG. 1. However, the optical system 110 in FIG. 8 also comprises an optical waveguide 301. The optical waveguide 301 guides the beam path 81 of the light 90, formulated in general terms, to the imaging HOE 130. In the illustrated example, the optical waveguide 301 also guides the light 90 to the deflection element HOE 120, and onward from the deflection element 120 to the imaging HOE 130. The optical waveguide 301 can guide the light, for example by way of total-internal reflection at its interfaces to the surrounding optically thinner medium.

This means that an input coupling surface 302 of the optical waveguide 301 is arranged between the refractive or mirror-optical element 171, for example a collimator lens, and the light-shaping HOE 120. For example, if use is made of a refractive collimator lens, then the input coupling surface 302 could be oriented perpendicular to the optical axis of the collimator lens.

However, it would in principle also be conceivable that the input coupling surface 302 is for example arranged between the light-shaping HOE 120 and the imaging HOE 130.

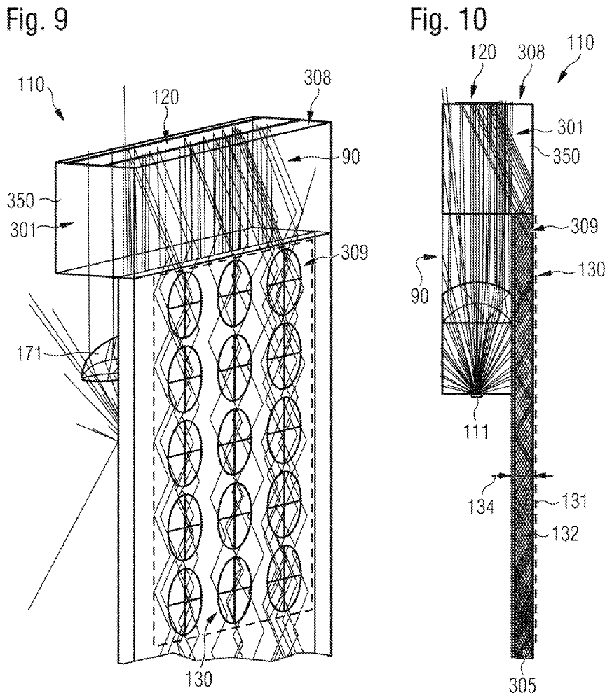

A particularly compact structure of the optical system 110 can be enabled by the use of the optical waveguide 301. By way of example, the optical waveguide 301 can realize the substrate 132 on which the imaging HOE 130 is arranged. By guiding the light 90 in the optical waveguide 301 and along the refractive index-modulated region 131, it is thus possible to dimension the thickness 134 of the substrate 132 or optical waveguide 301 to be comparatively small (e.g., in comparison with the scenario of FIG. 2). Such a scenario is depicted in FIG. 9 and FIG. 10 for an exemplary structural realization.

FIG. 9 is a perspective view of an exemplary structural realization of the optical system 110 from FIG. 8 with the optical waveguide 301. FIG. 10 is a side view of the structural realization of the optical system 110 from FIG. 9.

It is evident from FIG. 9 and FIG. 10 that the optical waveguide 301 is formed from bulk material, for example glass or plastic. The optical waveguide 301 can be realized as an optical block 350. The deflection element—realized here as light-shaping HOE 120—is applied to an outer surface 308 of the optical waveguide 301, and the imaging HOE 130 is applied to an outer surface 309 of the optical waveguide 301 perpendicular thereto. In general, the light-shaping HOE and the imaging HOE 130 can be arranged on different outer surfaces.

It is evident from FIG. 9 that (unlike in FIG. 2) the light is incident on the refractive index-modulated region 131 of the imaging HOE 130 multiple times as a result of reflection in the optical waveguide 301, because the optical waveguide 301 extends below the imaging HOE 130 and realizes the substrate thereof. Hence, the thickness 134 is many times smaller than the lateral dimension 136, or in particular the length along the optical waveguide 301. In general, the thickness 134 may be no greater than 20% of the length of the imaging HOE 130 along the optical waveguide 130.

The beam cross section of the light 90 can also be reduced together with a reduced thickness 134. Hence, the lateral extent of the light-shaping HOE 120 can be reduced, making the design of the optical system 110 even more compact.

Aspects of the optical system 110 regarding the use of a plurality of optical channels are described hereinbelow.

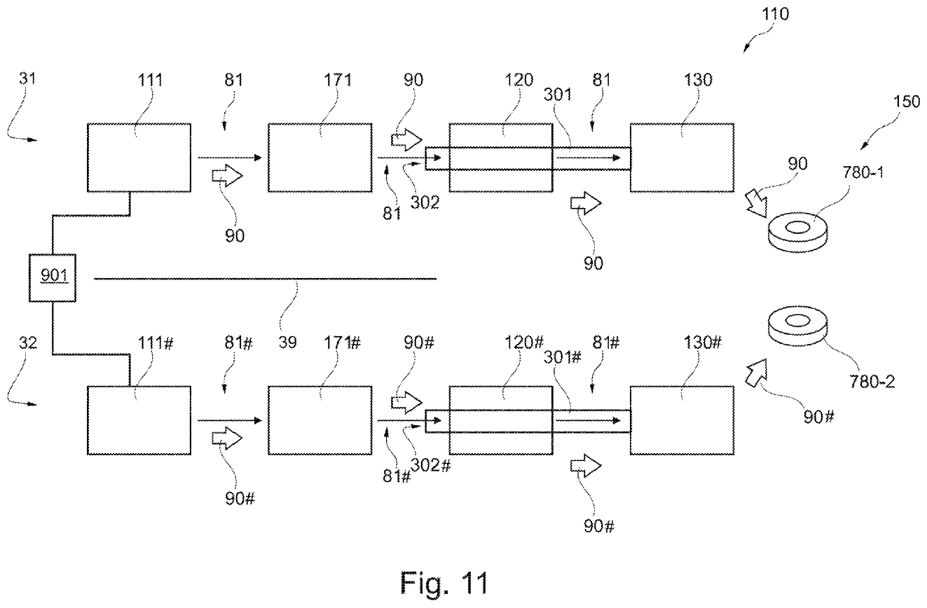

FIG. 11 illustrates aspects in connection with an optical system 110. FIG. 11 is a schematic illustration of the optical system 110, which is configured to generate a hologram 150. The optical system 110 in the example of FIG. 11 comprises two optical channels 31, 32.

The optical channel 31 corresponds to the example of FIG. 8 and was already discussed in the context of FIG. 8.

The optical system 110 also still comprises the further optical channel 32. The latter is realized in a manner analogous to the optical channel 31, which is to say it comprises a light source 111 #, a light-shaping HOE 171 #, and an optical waveguide 301 # with a corresponding input coupling surface 302 #.

Optionally, the optical system 110 may also comprise a stop element 39, which is arranged between the optical channels 31, 32 and avoids crosstalk of light between the optical channels 31, 32. The stop element 39 can be manufactured from light-absorbing material. The stop element 39 can for example extend between the respective light sources 111, 111 #, up to the collimator lenses 171, 171 #(or in general to refractive or mirror-optical elements as discussed hereinabove). The stop can be dispensable following the collimation.

The optical channels 31, 32 are configured accordingly in FIG. 11. Formulated in general terms, it is possible that the optical channels 31, 32 are configured differently in relation to the arrangement and/or presence of optical elements. A few exemplary variations are listed below:

First variation: For example, it is possible to dispense with the optical waveguide 301 and/or the optical waveguide 301 #—in a manner comparable to the optical channel 31 in the scenario of FIG. 1.

Second variation: While FIG. 11 and the subsequent figures each show two optical channels 31, 32, it would in principle be possible to realize a greater number of optical channels.

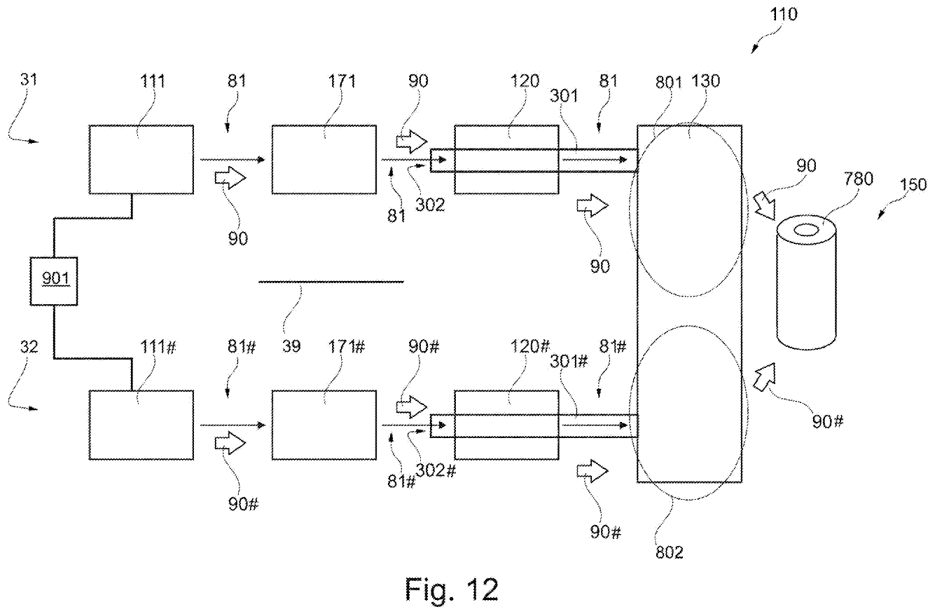

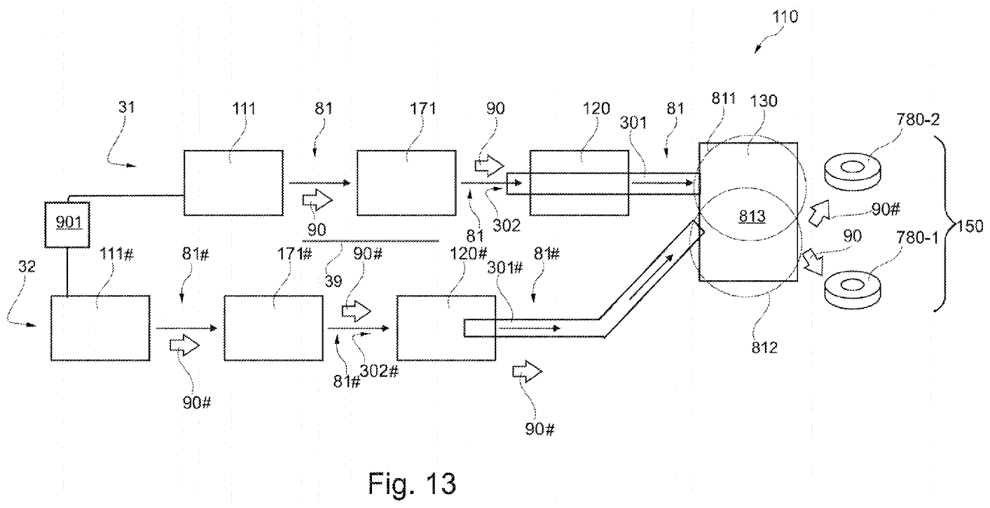

Third variation: In the example of FIG. 11, the optical channels 31, 32 address different imaging HOEs 130, 130 #, which each reconstruct a corresponding image motif 780-1, 780-2 of a hologram 150 by means of the light 90, 90 #. However, variants in which the optical channels 31, 32 address the same imaging HOE 130, for example in different or overlapping regions, would also be conceivable. Such examples are shown in FIG. 12 and FIG. 13.

In the example of FIG. 12, the first optical channel 31 is configured to illuminate the region 801 of the imaging HOE with light 90, and the second optical channel 32 is configured to illuminate the region 802 of the imaging HOE 130 with light 90 #. The region 801 and the region 802 are arranged next to one another. As a result, it is possible that a common image motif 780 is reconstructed by means of the light 90 and light 90 # if both optical channels 31, 32 are activated simultaneously. As a result, the corresponding image motif can have a particularly large-area embodiment.

Instead of such a realization as shown in FIG. 12, in which adjacently arranged regions 801, 802 are realized by the two optical channels 31, 32, it would also be conceivable that the optical channel 31 illuminates a first region of the imaging HOE 130 with the light 90 and the optical channel 32 illuminates a second region of the imaging HOE 130 with the light 90 #, with the first region and the second region having a common overlap region. Such an example is depicted in FIG. 13.

In the example of FIG. 13, the optical channel 31 is thus configured to illuminate the region 811 of the imaging HOE 130 with light 90, and the optical channel 32 is configured to illuminate the region 812 of the imaging HOE 130 with light 90 #. The region 801 and the region 802 have an overlap region 813, which is thus served by both optical channels.

In the illustrated example of FIG. 13, the light 90 is used to generate an image motif 780-1 within the framework of the hologram 150, and the light 90 # is used to generate an image motif 780-2 within the framework of the hologram 150. These image motifs can be arranged in the same spatial region, which is to say arranged in overlapping fashion in the volume of the hologram 150 (this is not represented in the schematic view of FIG. 13). For example, interaction elements, for instance buttons, could thus be displayed in the same spatial region, depending on whether the optical channel 31 or the optical channel 32 is activated.

Thus, this allows changing image motifs—e.g., interaction elements of a GUI—to be displayed at the same position, depending on which optical channel 31, 32 is activated. It is also possible to realize image motifs with different colors in one region (if the light 90 and the light 90 # use different wavelengths for the reconstruction). Such a geometry is particularly advantageous since this allows the image motifs to be separated both in terms of wavelength and in terms of reconstruction angle, and this makes it possible to avoid crosstalk between the optical channels. It would also be conceivable to incrementally switch the brightness by the addition of individual optical channels (with the same image motif and color).

A corresponding separation of the optical channels—in order to generate different image motifs 780-1, 780-2—can be realized in different ways; cf. Table 1.

Exemplary structural realizations of optical systems 110 with a plurality of optical channels are discussed hereinafter.

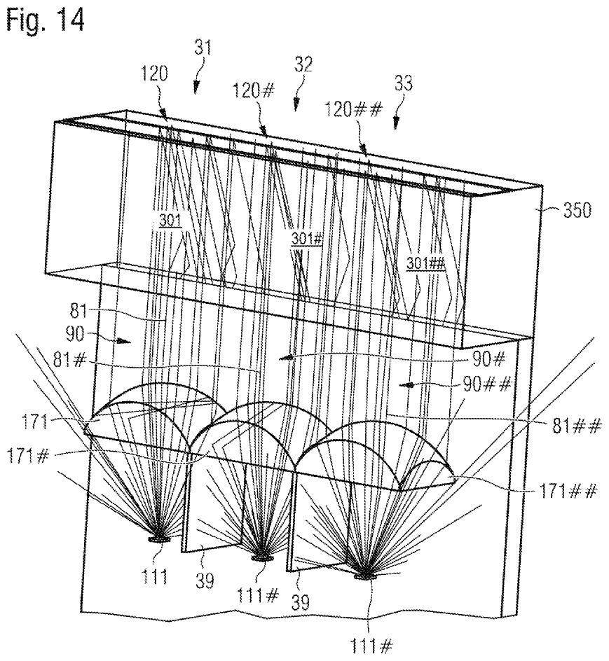

FIG. 14 is a perspective view with three optical channels 31, 32, 33, which have beam paths 81, 81 # and 81 ##, respectively, running parallel to one another. Light-guiding elements 301, 301 #, 301 ##, which are in the form of a joint optical block 350, are used. The collimator lenses 171, 171 #, 171 ## are also integrally formed, for example as a lens array. For example, the collimator lenses 171, 171 #, 171 ## could be produced in a joint injection molding process or in a joint 3-D printing process.

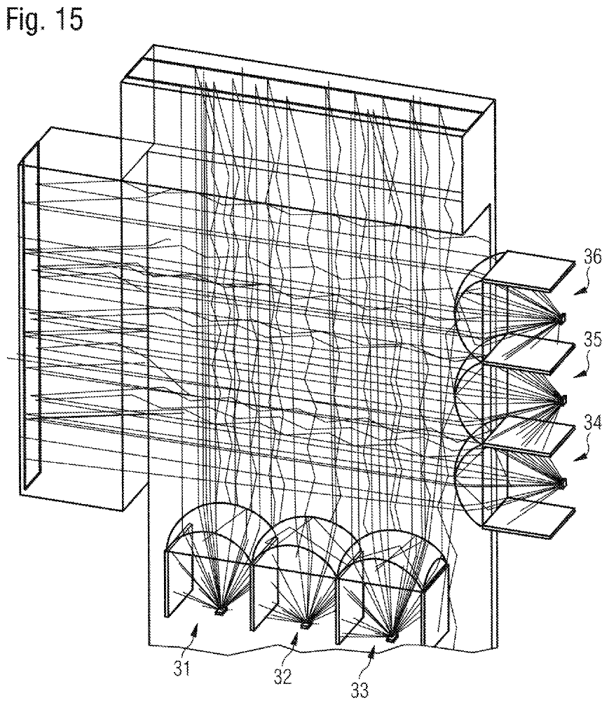

FIG. 15 is an enhancement of the example of FIG. 14. A total of six optical channels 31-36 are used in FIG. 15, wherein the optical channels 31-33 and 34-36 are respectively arranged perpendicular to one another (i.e., the corresponding beam paths include an angle of 90°). The channels 31-33 correspond to the example of FIG. 14; the channels 34-36 also correspond to the example of FIG. 14.

In this way, it is possible to form a line-column array for different imaging HOEs 130 or at least for different regions of a common imaging HOE. A line-column array of different image motifs could be reconstructed.

As a general rule, the beam paths of the various optical channels could form different angles with respect to one another, for example ranging from 450 to 90°.

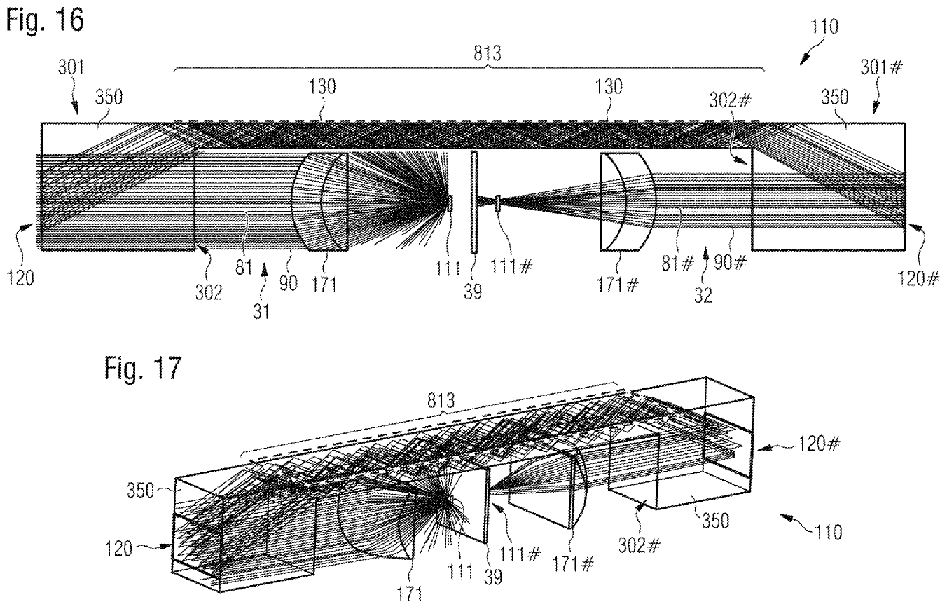

FIG. 16 is a further example of a possible implementation of the optical system 110 with two optical channels 31, 32, the beam paths 81, 81 # of which run parallel to one another, to be precise at an angle of 180° with respect to one another. Hence, the reconstruction angles differ by 180° in the azimuthal direction. FIG. 17 is a corresponding perspective view of the optical system from FIG. 16.

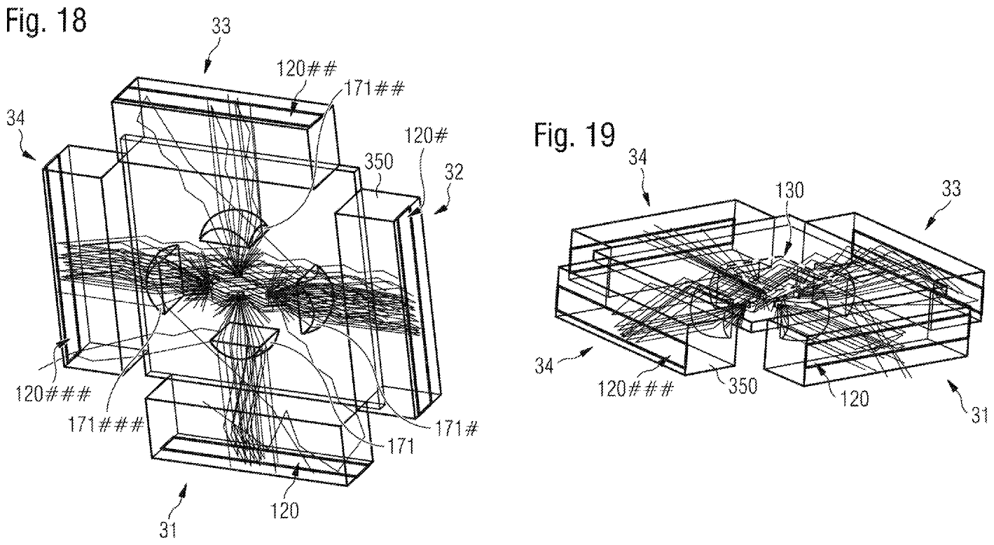

FIG. 18 and FIG. 19 show an optical system 110 in two different perspective views, the system being an enhancement of the optical system 110 from FIG. 16 and FIG. 17. The optical system 110 in FIG. 18 and FIG. 19 uses four optical channels 31-34, wherein two respective channels have beam paths that run parallel to one another and respectively correspond to the optical system 110 from FIG. 16 or FIG. 17.

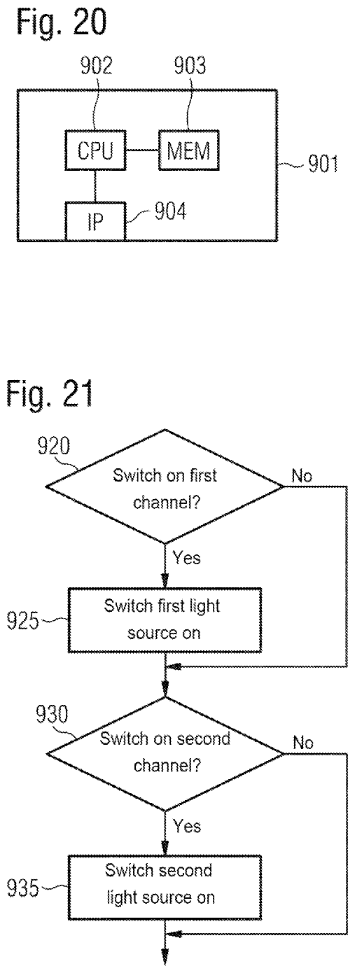

FIG. 20 schematically illustrates a controller according to various examples. FIG. 20 shows a data processing apparatus 901, which comprises a processor 902 and a memory 903. The data processing apparatus 901 realizes the controller, which is able to control a plurality of optical channels of an optical system as described above. To this end, the processor 902 can load and execute program code from the memory 903. Then, the processor 902 is able to separately switch individual light sources associated with different optical channels of the optical system on and off, by virtue of appropriate instructions being output via an interface 904. Thus, the processor 902 is able to control a plurality of light sources from different channels on an individual basis.

An exemplary method for controlling the optical system is described below in the context of FIG. 21.

FIG. 21 is a flowchart of an exemplary method. The method of FIG. 21 serves to control an optical device having a plurality of optical channels. For example, the optical system 110 can be controlled as described above.

The method of FIG. 21 could be carried out by a controller, for example by the processor 902 of the data processing apparatus 901, on the basis of program code from the memory 903 (cf. FIG. 20).

A check as to whether a first optical channel should be switched on is carried out in box 920. For example, a check as to whether a specific image motif of a floating hologram should be displayed could be carried out to this end, wherein the image motif intended for display is generated by the first optical channel.

Different decision criteria can be taken into account in the check in box 920. A few exemplary decision criteria are described in Table 3.

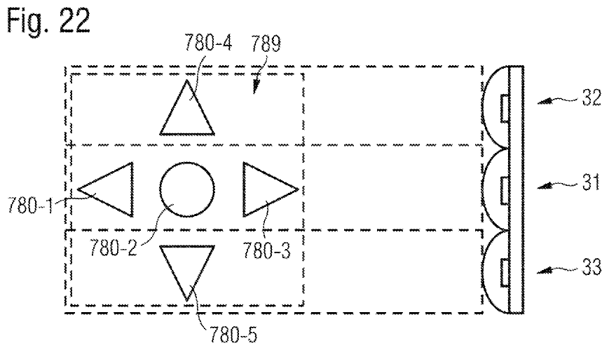

TABLE 3
Different decision criteria which can be considered
individually or cumulatively in box 920.

| | Brief description | Exemplary details |
|---|---|---|
| I | Motif | Different optical channels may be configured to display |
| | specification | different image motifs of a hologram. In that case, it is possible |
| | | to take a corresponding motif specification - obtained, for |
| | | example, from a control algorithm or a user input - into |
| | | account. For example, if different imaging HOEs 130, 130# are |
| | | addressed by the different optical channels (cf. FIG. 11), |
| | | different buttons in a GUI, for example, can be switched on/off |
| | | in this way. |
| II | Operational | For example, the controller could be configured to display |
| | state | different interaction elements in the GUI depending on the |
| | control | operational state of a control algorithm for a GUI. In this way, it |
| | algorithm | could be possible for example to switch dynamically between |
| | | different user interfaces of a GUI. An exemplary user interface |
| | | is depicted in FIG. 22. In the example of FIG. 22, navigation |
| | | buttons 780-1, 780-3, 780-4, and 780-5 (“cursor up, down, left, |
| | | right”) and a selection button 780-2 (“enter”) are generated by |
| | | a total of three optical channels 31-33. For example, the |
| | | corresponding menu 789 of the GUI could be displayed in a |
| | | specific operating state, for instance “selection”. If a different |
| | | operating state is activated (e.g., “playback control”), then |
| | | different buttons (e.g., “play”, “pause”, “fast-forward”, |
| | | “rewind”) could be displayed in the same spatial region. |
| III | Control | Parameterizations of a control algorithm could also be taken |
| | algorithm | into account in box 920. This means that a user could for |
| | parameterization | example select certain wishes for the motif specifications; |
| | | different menus of a GUI can be displayed accordingly, by virtue |
| | | of other optical channels being activated. The user could |
| | | activate different user interfaces, according to preferences. |
| IV | Depth sensor | It would also be possible for the controller to be configured to |
| | measurement | control the light sources for the different optical channels on |
| | signal | the basis of a measurement signal from the depth sensor 950. |
| | | For example, visual feedback could be output to a user in this |
| | | way if said user approaches an interaction element with a finger |
| | | (for instance: the button becomes brighter by virtue of a further |
| | | optical channel being added when fingers approach or when |
| | | actuation takes place). For example, it would be possible for the |
| | | controller 901 to be configured to determine state data |
| | | indicative of the user actuation of an interaction element |
| | | displayed as an image motif by the hologram. For example, if |
| | | the finger of the user approaches one of the interaction |
| | | elements 780-1-780-5 in the example of FIG. 22, then that |
| | | interaction element could shine more brightly or change color |
| | | by virtue of a further or different optical channel which |
| | | generates the same image motif in the same spatial region |
| | | being activated. For example, the orientation of a finger and/or |
| | | the parallax of the observer could be taken into account in the |
| | | process. |

Should the first optical channel be switched on, a first light source, which is associated with the first optical channel, is switched on in box 925.

A check corresponding to the check in box 920 is implemented in box 930, albeit for a further optical channel. Box 935 then corresponds to box 925 again, albeit for the further optical channel. Thus, the optical channels can be controlled on an individual basis.

It goes without saying that the features of the embodiments and aspects of the invention described above can be combined with one another. In particular, the features can be used not only in the combinations described but also in other combinations or on their own, without departing from the scope of the invention.

1. An optical system, comprising:
at least one imaging holographic optical element, HOE, configured to generate a floating hologram on the basis of light, said hologram being reconstructed in a volume outside of the at least one imaging HOE,
a plurality of optical channels each comprising a light source and a beam path configured to guide the light along the respective beam path to the at least one imaging HOE, and
a controller configured to individually control the light sources for the plurality of optical channels.

2. The optical system as claimed in claim 1, furthermore comprising a depth sensor configured to detect an object in the volume or adjacent to the volume, and output a corresponding measurement signal.

3. The optical system as claimed in claim 2, wherein the depth sensor is configured to detect the object using light at a wavelength which differs from the wavelength of the light used to generate the floating hologram.

4. The optical system as claimed in claim 2, wherein the controller is configured to control the light sources for the plurality of optical channels on the basis of the measurement signal.

5. The optical system as claimed in claim 2, wherein the controller is configured to use the measurement signal as a basis for determining state data indicative of the user actuation of an interaction element displayed as an image motif by the hologram.

6. The optical system as claimed in claim 5, wherein the controller is configured to determine the state data on the basis of an orientation of a finger in relation to the volume.

7. The optical system as claimed in claim 5, wherein the controller is configured to determine the state data dependent on a parallax of an observer of the hologram.

8. The optical system as claimed in claim 2, wherein the at least one imaging HOE is arranged between the depth sensor and the volume.

9. The optical system as claimed in claim 1, wherein the hologram is configured to display a plurality of interaction elements as image motifs,
wherein the image motifs of the plurality of interaction elements are generated by illuminating the at least one HOE with the light from the various beam paths.

10. The optical system as claimed in claim 9, wherein at least two of the plurality of interaction elements are arranged in the volume with overlap.

11. The optical system as claimed in claim 10, wherein the controller is configured to display different interaction elements of the at least two interaction elements of the plurality of interaction elements, depending on the operating state of a control algorithm.

12. The optical system as claimed in claim 10, wherein the controller is configured to display different interaction elements of the plurality of interaction elements, depending on the parameterization of a control algorithm.

13. The optical system as claimed in claim 1, furthermore comprising at least one deflection element configured to deflect the beam paths of the plurality of optical channels toward the imaging HOE.

14. A system, comprising:
the optical system as claimed in claim 1, and
a mirror surface extending along the at least one imaging HOE and arranged between the at least one imaging HOE and the volume.

15. The system as claimed in claim 14, furthermore comprising a cutout in the mirror surface arranged adjacent to the imaging HOE.

16. The system as claimed in claim 15, furthermore comprising a partly reflective layer which allows the light to pass and reflects ambient light.

17. A system, comprising:
the optical system as claimed in claim 1, and
an electronic visual display extending along the at least one imaging HOE,
wherein the at least one imaging HOE is arranged between the electronic visual display and the volume.

18. A computer-implemented method, comprising:
an individual control of a plurality of light sources in an optical system on the basis of one or more decision criteria,
wherein the plurality of light sources are assigned to a plurality of optical channels of the optical system, which each comprise an associated beam path and are configured to guide the light transmitted by the respective light source of the plurality of light sources toward at least one imaging holographic optical element, HOE, of the optical system,
wherein the at least one imaging HOE is configured to generate a floating hologram in a volume outside of the at least one imaging HOE on the basis of the light.

19. The computer-implemented method as claimed in claim 18, wherein the one or more decision criteria comprise a measurement signal from a depth sensor configured to detect an object in the volume or adjacent to the volume, and output a corresponding measurement signal.
